(19) United States
(12) Patent Application Publication
(10) Pub. No.: US 2002/0111172 A1
(43) Pub. Date: Aug. 15, 2002

(54) Location based profiling

(76) Inventors: Frederik M. DeWolf, Ithaca, NY (US); Douglas J. Ryder, Doylestown, PA (US); Charles A. Eldering, Doylestown, PA (US)

Correspondence Address: TECHNOLOGY, PATENTS AND LICENSING, INC., 340 NORTH BROAD STREET, DOYLESTOWN, PA, 18901, US

(21) Appl. No.: 09/782,962

(22) Filed: Feb. 14, 2001

(51) Int. Cl. H04Q 7/20

(52) U.S. Cl. 455/456; 455/414; 455/435; 342/357.01

(57) ABSTRACT

A method and system for profiling a subscriber based on location. A subscriber's daily activities and locations traveled while partaking in the activities are observed and a psychodemographic profile is developed from the subscriber's pattern of activities. The pattern of activities is associated with a time and a frequency component that is then used to predict a subscriber's activity.

### BACKGROUND OF THE INVENTION

The advent of wireless communications provides the ability for users to communicate from a moving location. Wireless communications requires a wireless device and a wireless network. Analog wireless devices provide the ability to transmit voice over the wireless network. Digital wireless devices provide the ability to transmit voice and data over the wireless network. In fact, the new digital wireless devices provide access to the Internet.

The use of wireless communications enables individuals to make transactions (either verbal or electronic, such as via the Internet) from a mobile location. Many transactions performed from a mobile location are independent of location. For example, you can talk to a friend or business associate, you can order a computer for your office, or you can search the Internet for office furniture. Any of these activities can be performed whether you are in Philadelphia or Los Angeles or whether you are at your desk, in a car or on a train. These types of transactions are often referred to as mobile commerce (M-commerce).

However, many mobile transactions require the location of the user be known. For example, calling for a tow truck to assist your stranded vehicle requires that you know your location in order for the transaction to be consummated. Furthermore, some transactions require the location be known so that the transaction can be routed to the appropriate party. For example, services such as the Emergency 911 System, require that the location be known so that the Emergency call can be routed to the appropriate call center.

Traditional fixed position telephones are assigned to a specific emergency call center. Moreover, the location of the call can readily be identified by the caller identification (CID) that is mapped to a specific physical location in the call center's database. Thus, an appropriate emergency services response can be made without further communication from the caller.

Wireless phones have no fixed position, therefore without communication from the caller to identify their present location an appropriate dispatch (emergency response team to the correct location) cannot be made. Moreover, the wireless phone is assigned to a home location so that a ‘911’ call is normally routed to the 911 emergency center associated with the home location, which could be on the other side of the country. Due to the above noted concerns with wireless phones adequately handling ‘911’ calls, the government has implemented regulations on it's 1996 Telecommunications Act that require cellular service providers be able to determine the location of a ‘911’ call within 1/10 mile or 121 meters by Oct. 1, 2001.

The industry is working on various alternatives to meet the government regulation requiring the service provider be able to determine a cellular phone's location. One alternative entails determining the location of the wireless device within the cellular phone network by calculating the differences in arrival time of the device's signal at one or more antennas in the system. U.S. Pat. No. 5,890,068 assigned to Cell-loc discloses one method and U.S. Pat. No. 5,999,124 assigned to Snap-Track discloses an alternative method.

An alternative technology that is being developed places global positioning satellite (GPS) functionality on a chip that is placed in the wireless device. The GPS chipset would provide the location of the cellular phone in coordinates that can be turned into a location. The GPS data could be combined with the caller ID data and forwarded to the call center as the emergency call was placed. Motorola disclosed such a GPS chipset in their product literature, “Motorola Announces Oncore™ Remote GPS Precision Timing Receiver”, printed from the World Wide Web site http://www.motorola.com/ies/GPS/pressrls/050498.html on May 5, 2000.

The use of GPS systems (GPSS) to determine an individual's location is becoming wide spread. For example, handheld devices have been developed that include a GPS receiver to determine an individual's location and map data so that the position of the individual can be displayed on a map. U.S. Pat. No. 5,528,248 assigned to Trimble Navigation discloses a personal location assistant (PLA), comprised of technology sufficient to determine present position as well as a compass that provides for taking readings of present and prior headings. The PLA is capable of receiving a downloadable map and retaining the map in computer memory. The PLA is then capable of providing directional readings, determining the devices position in terms of longitude and latitude, and overlaying the co-ordinations on a displayed digital map. The current heading can also then be displayed as an overlay allowing for highly accurate real time navigation.

The GPS functionality can be also be found in Handspring's Visor personal digital assistant (PDA) when used in combination with a Geode add-on module manufactured by GeoDiscovery. The Geode™ GPS Module is a global positioning system that slides into the Springboard slot of any Handspring Visor PDA. It works with GeoView™ Mobile Palm-based software that provides for the ability to place any position or location on an interactive map. The Geode™ includes a digital compass that senses the direction the unit is headed and orients the map accordingly. This is as disclosed on the GeoDiscovery website, http://www.geodiscovery.com/geodepp.html, printed May 17, 2000.

Another example of the expanding use of this technology is the deployment of vehicle navigation systems developed for the consumer market. These systems are generally found to be of two types. The first type is comprised of a GPS unit, a compass, a map database, and a user interface (visual and/or with a voice interface). The core functionality of the system (location determination, and relative position on a map) is enhanced by using input from the vehicle to provide other relevant data that can be used in aiding navigation. This input can be the speed of travel, and help in determining if turns (changes in direction) have been taken. This type of device is disclosed, U.S. Pat. No. 5,862,511 assigned to Magellan.

The second type of navigation system relies on the combination of a GPS unit, a cellular telephone and a call center. The position of the vehicle is determined by making use of the GPS unit. When a user initiates a session with the call center, the GPS unit relays the coordinates to the call center via a dedicated cellular telephone. The call center is staffed by an operator. The operator is able to view a map with the position of the vehicle displayed on it. The occupant of the vehicle is then able to converse with the call center operator who serves as the navigator, giving instructions and guidance to the occupant of the vehicle. The product literature from Onstar, “OnStar Services,” printed from the World Wide Web site http://www.onstar.com/service/services.htm on Jul. 7, 2000 discloses this type of service. This service is currently being offered as a dedicated service in vehicles that limits its portability and adaptability for use away from the vehicle.

This technology's primary benefit has been in providing emergency responses to mayday calls from the vehicle. With the GPS unit providing the current location, no other information is needed to coordinate an emergency response. This has been referred to as Automatic Vehicle Location (AVL). See Trimble Navigation, Ltd., U.S. Pat. No. USRE035920. Manufacturers of the vehicles have the ability to enhance this functionality by connecting this communication channel to the crash protection systems, typically airbag circuits, so that in the case of accident, an automatic crash notification (ACN) signal can be sent to the call center.

It has been through a separate set of developments that an advertising supported business model can be now applied to wireless communications. An article from the Wall Street Journal Interactive Edition, “Dial the Web: MobileID Invests in CellPhone Search Engine”, printed from the World Wide Web site http://interactive.wsj.com/archive/retrieve.cgi?id=SB964645721139 838971.djm&template-doclink.tmpl on Jul. 7, 2000, discloses just such a business model. The annoyance of having communications interrupted or delayed by advertisements and promotions may limit the acceptance of these services.

In other recent developments, the capabilities of PDA's have been expanded to provide wireless access to data, notably Palm Computings, Palm VII device and the wireless data service provided by the same company. In product literature from Palm, Inc. “Palm's Web Clipping Network”, obtained from the World Wide Web site http://www.palm.com/pr/palmvii/7whitepaper.pdf published on Jan. 1, 1998 discloses a PDA with wireless data access. This device makes use of a proprietary set of network servers to ‘clip’ data from Web Sites and to prepare the information in an appropriate format for devices using the Palm Operating System, or the Palm OS. Currently, these networks do not make use of automatically determining the subscriber's current location in order to deliver appropriate services.

Computer protocols have been developed that allow for the transfer of Internet content to cellular telephones. The telephones have evolved to provide for a larger display of information. As a subset of WWW protocols, Wireless Application Protocol (WAP) enables the conversion of Hyper Text Markup Language (HTML) or Extensible Markup Language (XML) formatted information into a thinner more streamlined set of data. WWW Server sites are preparing their information to be more suitable for transfer to WAP devices. These services are available to the public at the present on a limited basis.

Initial strides have been made in combining the delivery of marketing materials to these devices. The product literature from GeePS, “GeePS”, printed from the World Wide Web site http://www.geeps.com/technol.htm on May 27, 2000 discloses just the same service. A variation on this service is disclosed in product literature from Vicinity, “The Vicinity Business Finder”, printed from the World Wide Web site http://www.vicinity.com/vicinity/datasheets/finder.pdf on Jul. 24, 2000. These services are not ubiquitous and at the present have limited appeal either to consumers or retailers.

Pure proximity based services are not necessarily of significant value. It may be that while I am in close proximity to a McDonalds restaurant, and that McDonalds is currently running a marketing campaign that includes a coupon entitling me to a discount, and that I am equipped with a device capable of determining my location and that my service provider has agreed to deliver the marketing materials to its subscribers, I may never have eaten at a McDonalds nor might ever intend to. Sending me the advertisement would be both a waste of McDonalds time as well as mine. The service provider might irritate me with irrelevant materials to the point where I unsubscribe from their service.

Thus, there is a need for a system and method of generating a profile of a subscriber based on location that could be used to target advertisements to the subscriber.

### SUMMARY OF THE INVENTION

The present invention discloses a method and system for profiling a subscriber based on his activities and locations traveled. The subscriber activities and locations are observed and processed to develop a profile of the subscriber that may include demographics, psycho-graphic make-up and activity pattern of the subscriber.

According to one embodiment, a method for generating a profile of a subscriber by monitoring locations traveled by the subscriber as the subscriber partakes in daily activities is presented. The method includes receiving data related to a location of the subscriber and retrieving data characterizing the location. The profile is generated based upon the subscriber location data and the characteristics of the subscriber location data.

According to one embodiment, a subscriber activity profile is developed based on the observed activities. The subscriber activity profile is associated with time parameters as well as a frequency component and can be used to predict an activity prior to the subscriber partaking in it.

These and other features and objects of the invention will be more fully understood from the following detailed description of the preferred embodiments that should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates a generic wireless/satellite network that can be used to locate a mobile device;

FIG. 2 illustrates an exemplary use case diagram, according to one embodiment of the present invention;

FIG. 3 illustrates a communication platform for performing the profiling, according to one embodiment of the present invention;

FIGS. 4A and 4B illustrate an exemplary location profiling diagram and an exemplary location profile, respectively;

FIG. 5 illustrates an exemplary subscriber profiling activity diagram, according to one embodiment of the present invention;

FIG. 6 illustrates exemplary pseudo-code for predicting a subscriber activity and for updating the subscriber profile, according to one embodiment of the present invention;

FIG. 7A illustrates an exemplary subscriber activity profile, according to one embodiment of the present invention;

FIG. 7B illustrates an exemplary frequency measure of the subscriber location profile, according to one embodiment of the present invention;

FIG. 8A illustrates an exemplary probabilistic subscriber demographic profile, according to one embodiment of the present invention; and

FIG. 8B illustrates an exemplary data structure for storing the subscriber profile, according to one embodiment of the present invention.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

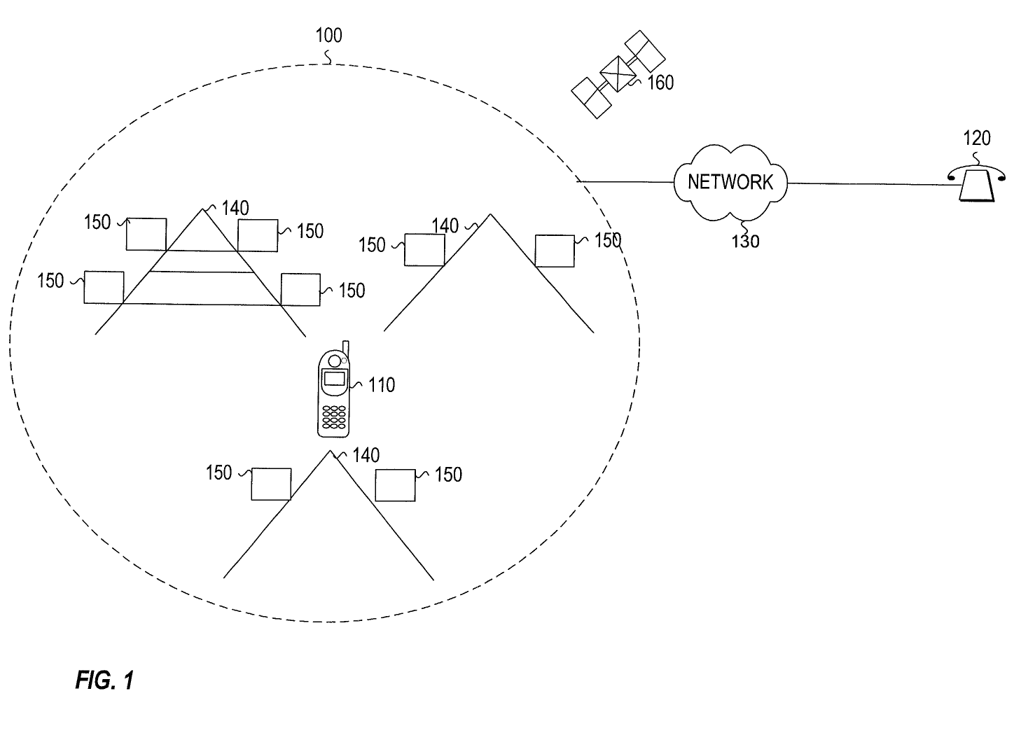

With reference to the drawings, in general, and FIGS. 1 through 8 in particular, the present invention is disclosed.

FIG. 1 illustrates a simplistic wireless network 100 connecting a wireless device 110 to a final destination 120 via a network 130. As illustrated the wireless device 110 is a wireless phone. However, as would be obvious to one of ordinary skill in the art, the wireless device 110 could be a personal digital assistant (PDA), such as a PALM Pilot or Handspring Visor, an internet enabled vehicle, a portable computer having a wireless Internet connection, a combination wireless phone/PDA or any other device now known or later conceived that provides wireless communications. As illustrated the final destination 120 is a stationary phone, but could be a wireless phone, a beeper, a service provider, the Internet, a private network, a computer, or numerous other devices without departing from the scope of the current invention.

As illustrated, the wireless network 100 consists of three towers 140. As one of ordinary skill in the art would recognize, the wireless network 100 would consist of a plurality of towers, with the number depending on the size of the network. As illustrated each of the towers 140 include multiple receivers 150. In practice, different wireless service providers operating out of that location probably have their own receiver 150 on the tower 140. The service provider may only handle calls for its own customers or it may also contract with other wireless providers to provide service for their customers. For example, if Verizon did not provide wireless service in California, they may contract with Pacific Bell for Pacific Bell to handle the wireless communications for them in California.

Wireless communications can be analog or digital. Moreover, there are numerous standards used for processing wireless digital communications, including but not limited to, code division multiple access (CDMA), global standard for mobile (GSM), personal communications system (PCS), Universal Mobile Telecommunications Systems (UMTS), and other 3G wireless systems. Wireless devices 110 and the wireless networks are developed to work with one of these standards. For example, Sprint phones and their wireless network are both based on the PCS standard. The PCS network cannot process communications from non-PCS wireless devices and the PCS wireless devices cannot communicate over non-PCS wireless networks. As one or ordinary skill in the art would recognize, most digital wireless devices can communicate in analog if digital service is not available. Moreover, it is within the scope of the current invention to have wireless devices and/or wireless networks that can communicate according to various standards.

Each of the towers 140 connects to the network 130. The network 130 may be a telecommunications (telecom) network, such as a public switched telephone network (PSTN), a hybrid fiber coaxial (HFC) network, a fiber to the curb (FTTC) network, a fiber to the home (FTTH) network, a digital subscriber line (DSL) network, other landline networks now known or later conceived, a satellite system, a wireless system, other systems now know or later discovered or a hybrid of these systems, without departing from the scope of the current invention. FIG. 1 also illustrates a GPS satellite 160 for providing latitude and longitude coordinates. As would be obvious to one of ordinary skill in the art, multiple GPS satellites would be required, however only one is illustrated for simplicity.

When the wireless device 110 initiates communications, a signal is sent from the wireless device 110 and is received by the receivers 150. The appropriate receiver 150 forwards the signal based on who the service provider is, whether they actually provide service in that location or are contracting with a local provider, and the destination of the communication. The location of the subscriber can be identified by the wireless system. For example, the location can be identified by determining the difference in time that the signal is received at three towers or the difference in the angle that the signal is received at two towers. Alternatively, a GPS chipset that is located within the device can determine the location of the subscriber.

As previously discussed, the location of the subscriber is important in order to route a ‘911’ call to the appropriate response center. In addition, the location of the subscriber can be utilized to assist in the delivery of information and services. Moreover, information pertaining to the location of a subscriber can be used to develop a profile of the consumer that can increase the effectiveness of information and services that are provided and/or offered to the consumer. Applicant's co-pending application having docket number L101-10 entitled “Location Based Delivery” filed concurrently with the present application describes a method for matching data (advertising, information and services) to a mobile subscriber and delivering the data to the mobile subscriber. Application L101-10 is herein incorporated in its entirety by reference, but is not admitted to be prior art.

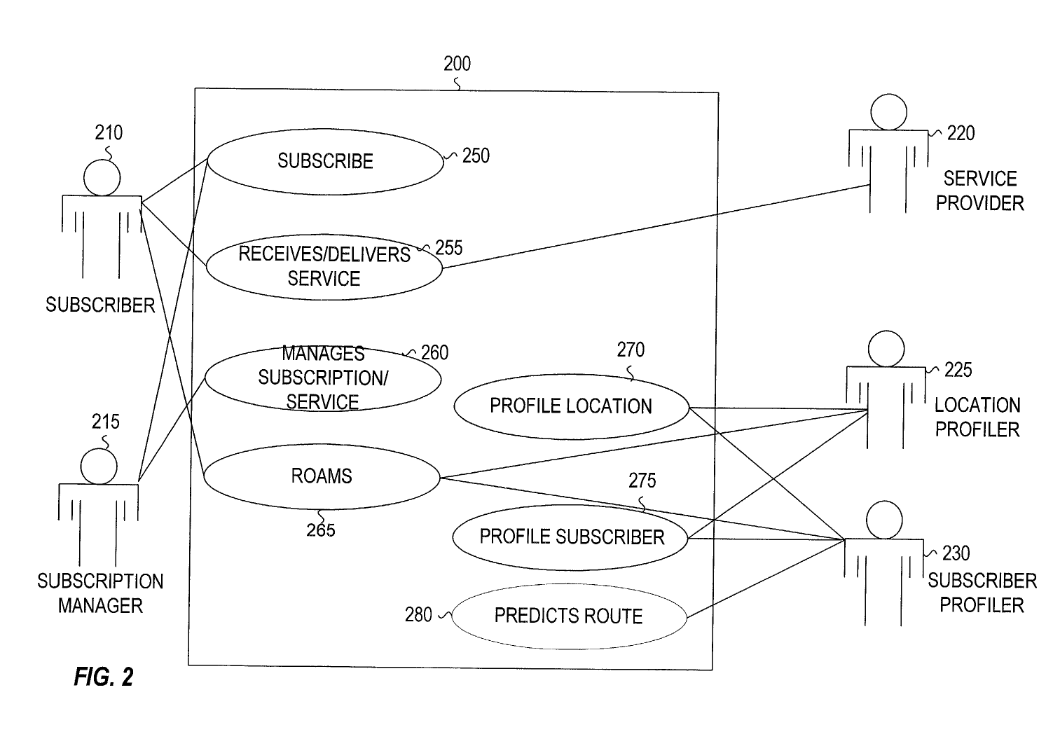

FIG. 2 is a use case diagram that illustrates the different actors involved in carrying out the method of the present invention along with a set of use cases, which represent the action performed, by those actors. As illustrated in the use case diagram 200, the set of actors involved in the present system includes a subscriber 210, a subscription manager 215, a service provider 220, a location profiler 225, and a subscriber profiler 230. The subscriber 210 subscribes (or registers) for a service (250) with the subscription manager 215 and receives the service (255) from the service provider 220. The subscription manager 215 subscribes customers (250) and manages the subscriptions, i.e., tracks the subscribers 210 and their services (260). The service provider 220 provides service to the subscribers 210 (255) based on the subscriptions managed by the subscription manager 215.

The subscriber 210 is receiving the service on a wireless device 110 and can thus roam (i.e., be mobile) (265) and receive service from any location (255). The location profiler 225 generates a profile of the location based on attributes (i.e., housing prices, type of community) associated with the location, and establishments (i.e., businesses, retail establishments) located within the location (270). The location profiler 225 may gather the data about attributes and establishments or this data may be provided to the location profiler 225 by a third party. Moreover, the location profiler 225 may use a map database to aid in the generation of the location profile. The map database may be generated by the location profiler 225 or may be provided by a third party.

The subscriber profiler 230 receives data about where the subscriber is roaming (265) and retrieves location profile data from the location profiler 225 in order to generate a profile of the subscriber (275) and to predict routing patterns of the subscriber 210 (280). In order to determine the profile (275) or routing (280) of the subscriber, attributes such as time of day, day of week may be collected in order to determine the type of activity (i.e., shopping, commuting). The location profiler 225 may also monitor the roaming of subscribers 210 (265) to determine the profile of the subscribers (275) passing through a particular location in order to update the location profile or create a new location profile (270).

As would be obvious to one of ordinary skill in the art, the service provider 220 may be providing any type of wireless service. For example, the wireless service may be telephone service, Internet access, private network access, paging service, data service, or any other wireless service now known or later conceived. The subscriber 210 may subscribe one or multiple devices, the devices including but not being limited to wireless phones, PDAs, wireless portable computers, and Internet enabled vehicles.

The actors illustrated in FIG. 2 may each be a separate entity, a single entity may perform the tasks associated with multiple actors, several entities may be required to perform the tasks associated with a single actor, or some combination thereof. For example, a wireless phone provider may be the service provider 220 and the subscriber profiler 230. Alternatively, one entity may track the location of a subscriber 210 and a separate entity may manipulate the data in order to determine potential routes for the subscriber 210 (the two in conjunction with each other forming the subscriber profiler 230). It should be noted that the use case diagram illustrated in FIG. 2 is simply an exemplary embodiment and that there are numerous variations to this embodiment or separate embodiments that are well within the scope of the current invention.

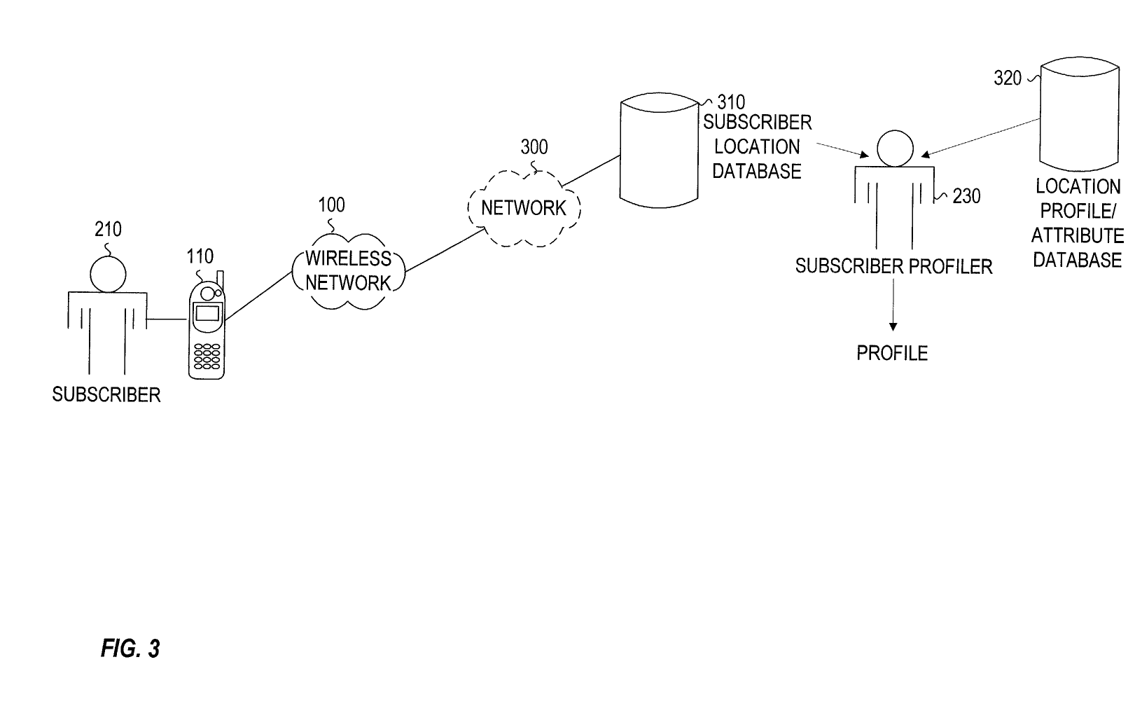

FIG. 3 illustrates a communication platform for supporting the method and system of the present invention. The subscriber 210 is connected to the wireless network 100 via the wireless device 110. As the subscriber 210 roams, his/her location is determined either by the wireless network 100 or by using the GPS network 160. Data related to the subscriber's location is forwarded to a subscriber location database 310. The subscriber location database 310 may be part of the wireless network 100 or may be external to the wireless network 100. The location data may be saved to the subscriber location database 310 directly from the wireless network 100 or it may be sent from the wireless network 100 to a network 300 that in turn saves the data in the database 310. The network 300 may be a telecom network, a private network, the Internet, or any other network capable of providing communications. The wireless service provider may maintain the subscriber location database 310 or a third party may maintain it. The location data saved may be raw data or may be aggregated data.

In one embodiment, the wireless network 100 determines the location of the wireless device 110. For this embodiment, the wireless device 110 needs to be powered on and communicating with the wireless network 100 (i.e., establishing a communication channel with an appropriate service provider, making a phone call, browsing the web). When communications are initiated by the subscriber (i.e., phone call), a signal is available for determining the location all of the time. The location data may be saved all of the time, at set intervals, or only at the initiation and conclusion of the communication. The preferred embodiment would be to capture and save the data at set intervals, for example every five 5 minutes.

In another embodiment, the wireless device 110 may communicate with the wireless network 100 even if the subscriber 210 did not initiate the communications. The subscriber's location can be determined by the wireless network 110 using this communication (non-subscriber initiated communication). For example, the wireless device 110 may send an “I'm alive” signal when it is first powered on, may respond to the status checks from the wireless network 100, or may respond to the broadcast signals from the wireless network 100 (i.e., send an ACK). In a preferred embodiment, the wireless device 110 would communicate with the wireless network 100 in some fashion at predefined intervals, such as every 5 minutes. Alternatively, the wireless device 110 may transmit a signal to the wireless network 100 on its own (not in response to the status check or broadcast signal Once the location of the wireless device 110 is determined, the data needs to be stored and processed. According to one embodiment, everytime the wireless network 100 determines the location of the subscriber 210, the location data will be forwarded to the subscriber location database 310. According to another embodiment, only a portion of the location data generated will be forwarded. For example, the location data may only be forwarded when a call is made even though the location is determined at fixed intervals. The location data may be generated continuously during a communication (i.e., phone call) but the location is only transmitted to the subscriber location database 310 during set up and completion of the communication.

According to another embodiment of the invention, the wireless network 100 determines the location and forwards the location data to the wireless device 110. For example, the wireless network 100 may transmit the location data to the wireless device 110 as part of the communications sequence, may transmit the location data in a separate signal (i.e., location signal), may transmit the location data along with an identifier identifying the particular device as part of the broadcast signal, or other methods that are now known or are later conceived that would be obvious to one of ordinary skill in the art. Once the wireless device 110 receives the location data, the wireless device 110 would then need to store the location data. As one of ordinary skill in the art would recognize, to store the data the wireless device 110 would require some sort of memory. Thus, this embodiment is envisioned for any wireless device 110 having memory built-in to the device or having a memory module connected thereto. The memory module could be any type of memory device, such as a memory stick from Sony Corporation. Currently wireless devices 110 such as wireless computers, PDAs and some of the newer web-enabled phones have memory and could fairly easily be configured to store this location data.

If the location data is stored within the wireless device 110, the location data will be transmitted to the subscriber location database 310 at some point. The location data may be transmitted to the subscriber location database 310 in various manners, including but not limited to, everytime a communication (i.e., phone call) is initiated, at predefined intervals (i.e., every hour), at predefined times (i.e., every day at 3AM), when the subscriber determines (i.e., hits a button or a sequence of keys), when the wireless device 110 is queried by the wireless network 100, or when the wireless device 110 is queried by the subscriber location database 310 (or the party maintaining the database).

The wireless device 110 may transmit all of the location data in raw form or if the device is equipped with a processor, the wireless devise 110 may process the location data prior to transmitting. The processing of the location data may be as simple as converting location coordinates into an actual location on a map (32 lat, 34 long=340 North Broad Street, Doylestown Pa. 18901) or may be converting the location coordinates into a description of the location (32 lat, 34 long=industrial section of historic town). The processing may also be aggregating the data in some fashion (i.e., time of day, at certain location, within a certain vicinity, traveling, stationary). As one of ordinary skill in the art would recognize there are numerous way to process the data, all of which would be within the scope of the current invention.

According to another embodiment, the GPS network 160 determines the location of the subscriber 210. In this embodiment, the wireless device 110 learns its location by utilizing the GPS chipset that is contained therein. The GPS chipset receives the location coordinates for the wireless device 110 from the GPS network 160. The GPS chipset knows the location of the device at all times. According to one embodiment, the wireless device 110 stores the location data. The wireless device 110 may store the location data all the time, at set intervals, when the subscriber determines, etc. As described above, the wireless device 110 may transmit the raw location data to the subscriber location database 310 (via the wireless network 100 directly or a combination of the wireless network 100 and the network 300), or may process the location data before forwarding. The location data (raw or processed) may be transmitted all of the time, at set intervals, or when a communication is established (i.e., a call is made). As one of ordinary skill in the art would recognize, there are numerous methods for transmitting the location data to the subscriber location database that would be well within the scope of the current invention.

According to a preferred embodiment of the current invention, in addition to location data being stored in the subscriber location database 310, the time associated with the location will also be stored. The subscriber profiler 230 extracts data from the subscriber location database 310 and generates predicted routes for the subscriber 210 (discussed in further detail later).

In addition, the subscriber profiler 230 extracts data from a location profile/attribute database 320. The location profile/attribute database 320 consists of data related to locations. For example, the location profile/attribute database 320 may include the type of businesses, stores, points of interests, etc. associated with locations. Moreover, the location profile/attribute database 320 may include data on characteristics associated with the location, intended visitors to the location, establishments within the location, etc. The characteristics may include but are not limited to demographics, store preferences, product preferences, likes and dislikes.

The subscriber profiler 230 may use the data from the location profile/attribute database 320 to identify the type of establishments that the subscriber 210 may pass on the predicted routes. Furthermore, the subscriber profiler 230 may generate a profile of the subscriber based on the data from the two databases 310, 320. The subscriber profile may include a probabilistic determination of the demographic make-up (i.e., race, age, gender, income), and the preferences (i.e., product, store) of the subscriber 210. The generation of the profile will be discussed in more detail later.

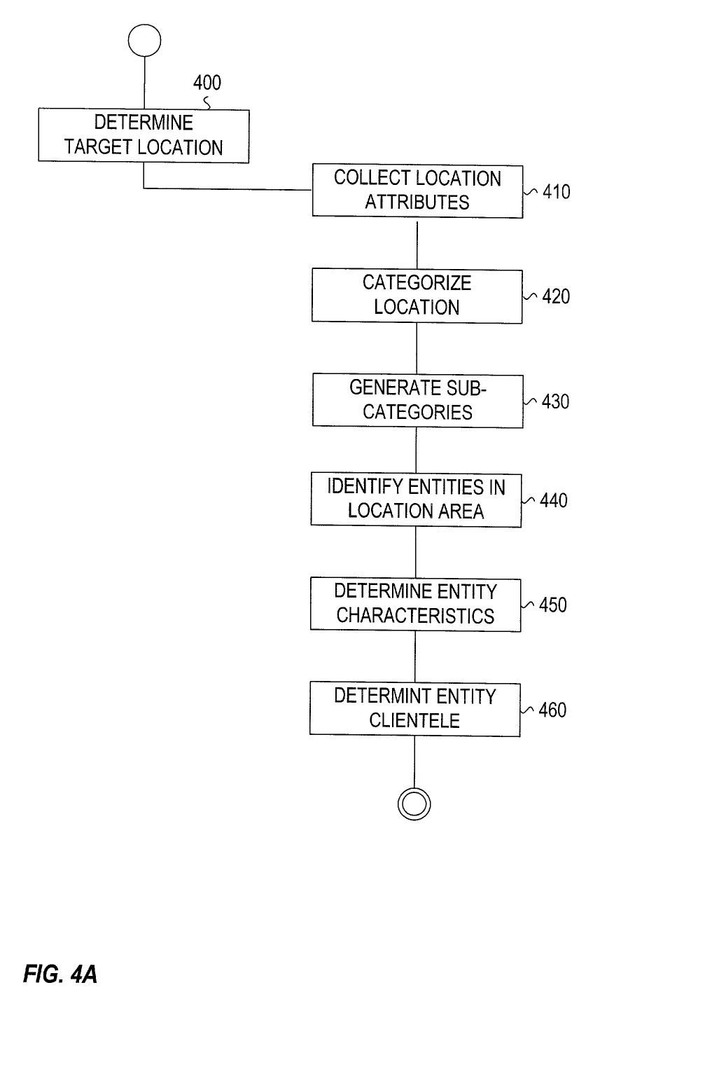

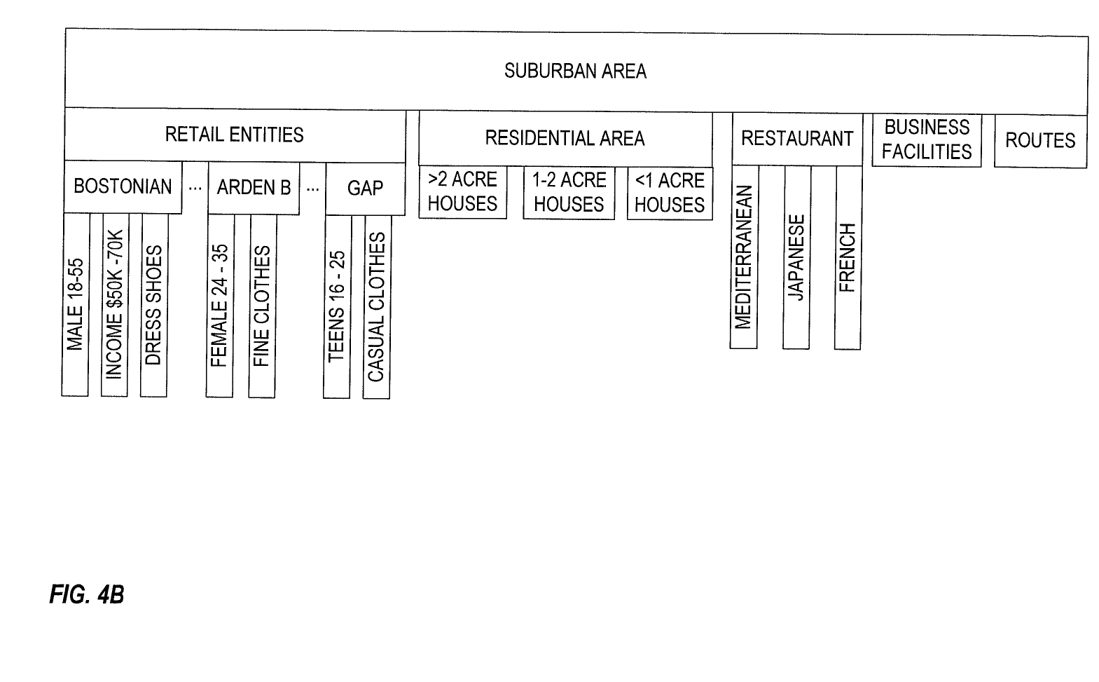

FIG. 4A illustrates an activity diagram (process) for generating a location profile that would likely be stored in the location profile/attribute database 320 of FIG. 3. The location profile includes but is not limited to the location type, the type of entities in that location, and the clientele or characteristics of those entities. Initially, the location profiler 225 determines a target location to profile (step 400). The target location may be any geographical area that is part of a location database and that is identifiable by a set of geographic coordinates. Initially attributes about the geographical area are collected (step 410). These attributes include but are not limited to parks, shopping centers, residential areas, business districts, highways, and routes. The location attributes are used to categorize the location area (step 420). The entire location area may fall into one category or the location area may be defined by multiple categories. The location categories include residential area, commercial area, industrial zone, suburban zone or other location types that would be obvious to one of ordinary skill in the art. As an example, a location having residential houses and a few convenient stores may be categorized as a residential area, whereas a location with a shopping mall and other service-oriented businesses may be categorized as a commercial area.

In one embodiment, the location profiler 225 breaks the location category into sub-categories (step 430). The subcategories include but are not limited to retail establishments, residential areas, restaurants, businesses, and routes. The subcategories defined may vary based on the location categorization. Within each sub-category, specific entities are identified (step 440). The specific entity may be a particular establishment or may be a type of establishment. For example, retail establishments such as the GAP may be identified or restaurants having a particular cuisine (i.e., Mexican) may be identified. As one of ordinary skill in the art would recognize, there are numerous ways to identify entities that would be within the scope of the current invention.

Once the entity is defined, specific characteristics associated with the entity are defined (step 450). For example, casual clothing may be a characteristic that was identified with the GAP. Alternatively, if the entity was Mexican cuisine the characteristic defined may be authentic vs. chain or may be the particular restaurants. Next the clientele (or target clientele) of the entities is determined (step 460). The clientele may be defined as psycho-demographical attributes associated with consumers of the product or service. The psycho-demographical attributes may include gender, age, income, marital status, hobbies, and other information that characterize the consumer. The clientele is determined from available market research data that identifies consumers that use or are likely to use the entities' services. The psycho-demographical attributes may be defined in deterministic or probabilistic values. For example, the target market may be defined as 18-25 year olds (deterministic) or may be defined as 20% for 16-17 year olds, 70% for 18-25 year olds, and 10% for 25-29 year olds (probabilistic).

The method above is only illustrative and is not intended to limit the scope of the invention. As one of ordinary skill in the art would recognize, the order of the above method could be modified, additional steps could be added, steps could be removed, or a different process producing the same or a similar result could be implemented without departing from the scope of the current invention. It should also be obvious that each subcategory may not have the same breakout, and in fact some subcategories may have more or less breakdown or may have a completely separate breakdown then that defined above with respect to FIG. 4A.

FIG. 4B illustrates an exemplary location profile with logical sub-divisions for the location. As illustrated, the location is identified as a suburban area (step 420). The suburban area includes different sub-categories such as retail entities, residential areas, restaurants, business facilities, and routes (step 430). As would be obvious to one of ordinary skill in the art, numerous other sub-categories could be included.

Within the retail sub-category specific entities such as Bostonian, Arden B, GAP are illustrated (step 440). Each entity (store) is defined by a characteristic, such as dress shoes, fine clothes and casual clothes (step 450). The intended target market (clientele) is then defined (step 460). As illustrated the target market is defined by demographics. For example, the target market for the Bostonian store may be males between the age of 28-55 having an annual income between $50K and $70K.

As illustrated, the residential area may be characterized in terms of land associated with the house. Other characteristics (not illustrated) that could define the residential area, include but are not limited to, home size (i.e., square feet, levels, bedrooms), average annual income and average family size. The residential area could also initially be defined by area and then further broken out under the areas.

As illustrated, the restaurants may be characterized by the ethnic origin of the food served, i.e., Mediterranean, Japanese, French, Senegalese (not illustrated), etc. The particular restaurants could be defined under the ethnic origin or the demographics associated with the clientele could be defined. Characteristics associated with business facilities could be the type of business (not shown) that includes but is not limited to small business, consulting firm, and high-tech start-up. Characteristics associated with routes could be the type of roads (not shown) that include but are not limited to highway, low traffic street, etc.

As one of ordinary skill in the art would recognize, a location profile could consist of various different breakouts that would be well within the scope of the current invention. For example, the location could be classified as a zip code and the zip code could be defined by areas (i.e., commercial, residential, business, retail). The areas could then define attributes (i.e., subdivisions defining the residential, type of stores defining the retail). The attributes could then be further defined (i.e., house price for subdivision, store names for type of stores).

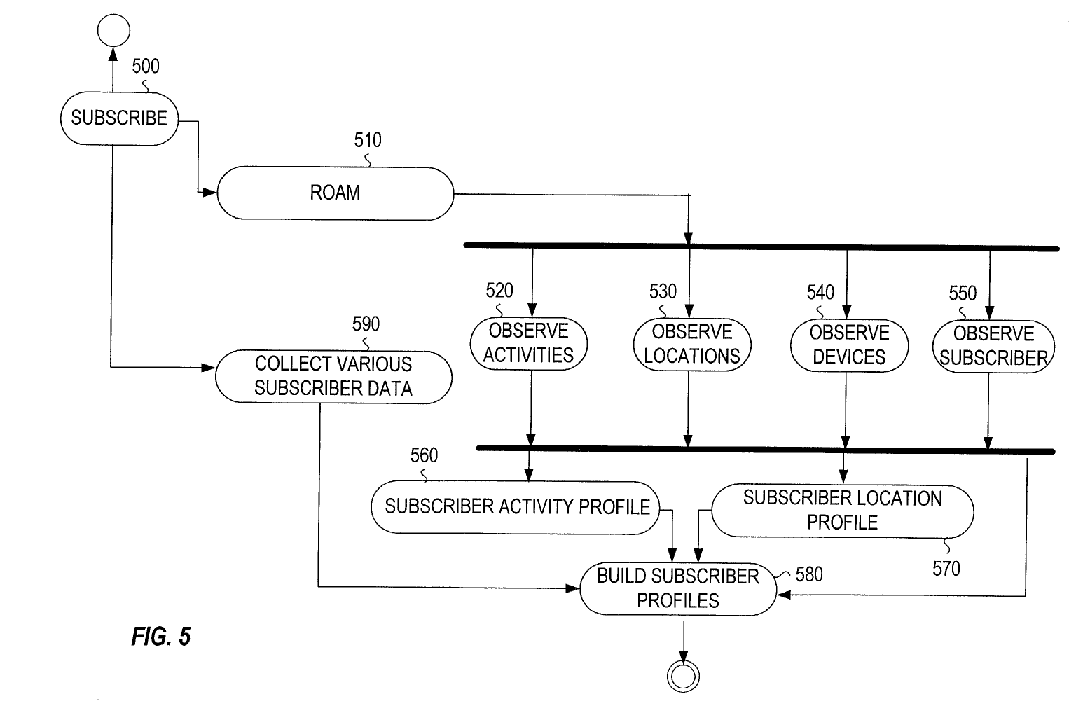

FIG. 5 illustrates an activity diagram for profiling a subscriber 210. Initially a subscriber 210 subscribes to receive wireless service (step 500). The subscriber 210 roams (step 510) with his wireless device 110 and the location of the wireless device 110 is determined in accordance with one of the methods described above (i.e., the wireless network or the GPS chipset). Data related to the subscriber's location and time at that location, such as time of day, day of week, etc. are stored in the subscriber location database 310 and processed. When processing the data, the subscriber profiler 230 observes activities that the subscriber 210 partakes in (step 520), observes locations that the subscriber 210 visits (step 530), observes the wireless devices 110 that the subscriber 210 uses (step 540), and observes which subscriber (if the subscriber is actually a household of different users) is using the device (step 550).

The observed activities (step 520) are categorized by analyzing the time data, frequency, route, etc. associated with the subscriber 210. For example, if Monday through Friday mornings between approximately 8:00 AM and 9:00 AM the subscriber takes roughly the same path between Doylestown, Pa. and Philadelphia, Pa., an analogy can be made that the subscriber 210 is commuting to work. Another example, may be that if on Saturday mornings the subscriber goes to numerous locations within town, an analogy can be made that the subscriber 210 is running errands. As one of ordinary skill in the art would recognize, there are rules that could be applied that could classify the type of activities that a subscriber 210 was performing. The classification may be in the form of a probability. That is, depending on the time, the location and other features, a determination might be made that there is an 80% chance that the activity the subscriber 210 is partaking in (or is about to partake in) is an errand.

The observed locations (step 530) are based on particular locations that the subscriber 210 visits. The observed locations may be defined by the days of the week, or the times of day that the location is visited. For example, the subscriber 210 visits the store 7-11 on Mondays between 7:30 and 8:00. Additionally, the observed locations may be defined in terms of time spent at the location. For example, in the last week the subscriber 210 was at the park for 3 hours.

The observed devices (step 540) are generated based on the wireless device 110 (or devices) that the subscriber 210 uses. As previously discussed there are numerous types of wireless devices 110 that include but are not limited to wireless phones, PDAs, and Internet enabled vehicles. The subscriber 210 may always only use one wireless device 110 or the subscriber 210 may use different wireless devices based on the day, the time, the activity, or the location. For example, if the subscriber 210 is traveling for work they may be traveling in an Internet enabled car, have their PDA, and wireless phone. However, if the subscriber 210 is spending time with the family they may only have the wireless phone. Determining when the subscriber 210 uses each device or combination of devices may be useful in determining an activity of the subscriber 210, developing a predicted route of the subscriber 210, developing a profile of the subscriber 210, or other determinations that would be obvious to one of ordinary skill in the art.

The observed activities (520), locations (530), devices (540), and subscribers (550) can be used to develop profiles of the subscriber. The profiles include an activity/routing profile (560), a location profile (570), and a subscriber profile (580). The profiles may be generated based simply on the observed data or may be based on the observed data and characteristics associated with the observed data.

The activity/route profile 560 may be generated based solely on the observed activities (520), and simply predict the activity (or route) of a subscriber 210 at a particular time. For example, the activity/route profile (560) may predict that on Monday morning the subscriber 210 is going to commute to work. Another example may be that on Tuesday nights on the way home from work, the subscriber 210 will stop at the grocery store. According to one embodiment, the activity/route profile may be generated based on some combination of the observed data (activities, location, device, subscriber). Additionally, the activity/route profile may obtain data about the entities that the subscriber 210 is likely to pass on the route to enhance the activity/route profile.

The activity/route profile can be used to provide advertisements or services (i.e., traffic reports) to the subscriber 210. The advertisements/services may be delivered either before (i.e., the night before, the hour before) or during the activity (or route). The advertisements may be delivered via the wireless device 110 or may be delivered via another media, which includes but is not limited to television, mail, or the Internet. The delivery of advertisements to the subscriber 210 may also be a combination of media. As one skilled in the art would recognize there would be coordination required to have an advertisement targeted to a subscriber 210 via multiple media in a coordinated effort. An example of a coordinated advertisement scheme could take place for a subscriber 210 whose activity/route profile predicts that the person commutes to work early in the morning and passes a coffee shop. The subscriber 210 may be delivered an advertisement for the coffee shop on the television the night before, may see an advertisement for the coffee shop in the morning paper, and then may receive an ad for the coffee shop on their wireless device 110 as they begin their commute.

Obviously if the subscriber 210 doesn't like coffee then delivering the subscriber 210 an advertisement for a coffee shop is probably of little or no value. Thus, in a preferred embodiment, the activity/route profile is enhanced by incorporating the subscriber profile (discussed in more detail below). That is, the activity/route profile would be enhanced by identifying the entities on a predicted route that would be of interest to the subscriber 210.

The activity/route profile may be deterministic (i.e., activity is commuting, route is Interstate 95) or may be probabilistic (activity is 80% chance of commuting and 20% of entertainment, route is 70% I-95, 20% I-83 and 10% N/A). As should be obvious, one difference in the commuting patterns may be the traffic. Thus, one embodiment would include the wireless device 110 obtaining data (i.e., traffic, weather) about the potential predicted paths and suggesting a path to the subscriber 210 based on this data.

Both the route portion and the activity portion of the activity/route profile can be updated based on the actions of the subscriber 210 (i.e., as they roam). For example, the activity/route profile may predict that the subscriber 210 is commuting to work and that there is an 80% chance they will commute via Interstate 95 and a 20% chance they will commute via Interstate 83. If the subscriber 210 takes a left out of the driveway, the route can be updated to reflect the fact that the subscriber 210 is most likely taking an alternative path (i.e., Interstate 83 instead of Interstate 95 in the above example). If the subscriber 210 takes an unexpected turn or heads in an unexpected direction, the route may be defined as unknown. Alternatively, if the subscriber 210 travels a certain path on a Friday evening the activity may be updated from commuting to entertainment (i.e., happy hour).

The activity/route profile can predict certain activities and routes in advance (i.e., commuting) while other activities and routes can be predicted as the subscriber roams (i.e., going to the mall). The predicted routes may be independent of an activity, but in a preferred embodiment are associated with an activity. As defined, the predicted activity and predicted route were combined in one profile. The activity profile and the route profile may also be separate without departing from the scope of the current invention. As would be obvious to one skilled in the art there are numerous activities and routes that could be predicted and numerous methods of making these predictions that would be well within the scope of the current invention.

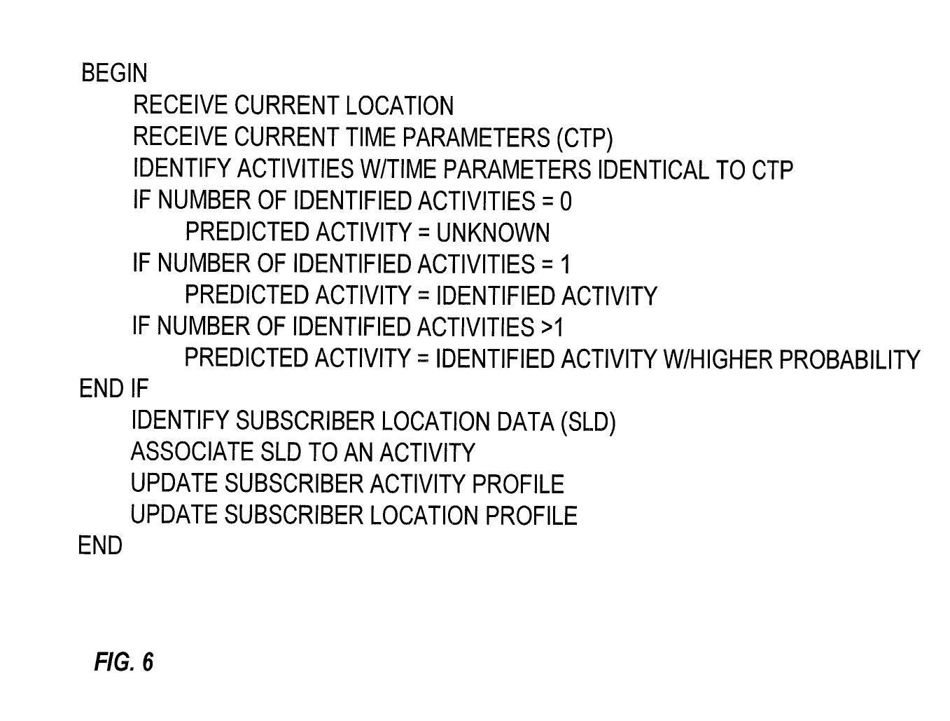

FIG. 6 illustrates exemplarily pseudo-code for predicting a subscriber activity and for updating the subscriber profile. The subscriber profiler receives from the device in use by the subscriber the current location and the current time parameters (CTP). The subscriber current location may be a route, a commercial entity or any other location that can be identified by the GPS system. The CTP relate to the time of day (ToD), day of week (DoW), the season and other parameters that can be used to precisely characterize the present moment in time. Based on stored time parameters associated to the subscriber previous activities, the profiler may identify the activities having time parameters similar, within a certain time margin, to the CTP. For example, a previous set of time parameters may have a ToD of 8:03AM while the CTP may have a current ToD of 8:20AM. For a system configured to tolerate a ToD differential of 0 to 30 min, both ToD would be equivalent under that tolerance level.

As illustrated in FIG. 6, if no activity having similar time parameters with the CTP is identified, the predicted activity is set to unknown. In this instance, the system may not be able to predict the subscriber activity based on prior information. However, using the current subscriber location and the location profile it may be possible to predict the subscriber activity. This situation may arise when the subscriber is performing a new activity or he is modifying his life habits, due to a change in his preferences, schedule or habits. For example, the subscriber may start working on weekends due to new conditions on his workplace. In such situation, the work commute will have new time parameters that may not have been previously associated to any activity. The subscriber current location, which may be part of the subscriber location profile, may then point to a work commute activity.

In the case where only one activity is identified as having similar time parameters with the CTP, this identified activity is set as the predicted activity. For a number of identified activities superior to 1, the identified activity with the highest frequency is set as the predicted activity.

Although the exemplary activity prediction pseudo-code uses only time parameters, the system may use additional information such as current location information to predict the activity. The current location may be compared to stored subscriber location profile that includes a list of destinations where the subscriber has been in conducting an activity and also the different paths taken by the subscriber in getting to those destinations. If the current location is included in one path of the location profile, the activity associated with that path may then be set as the predicted activity.

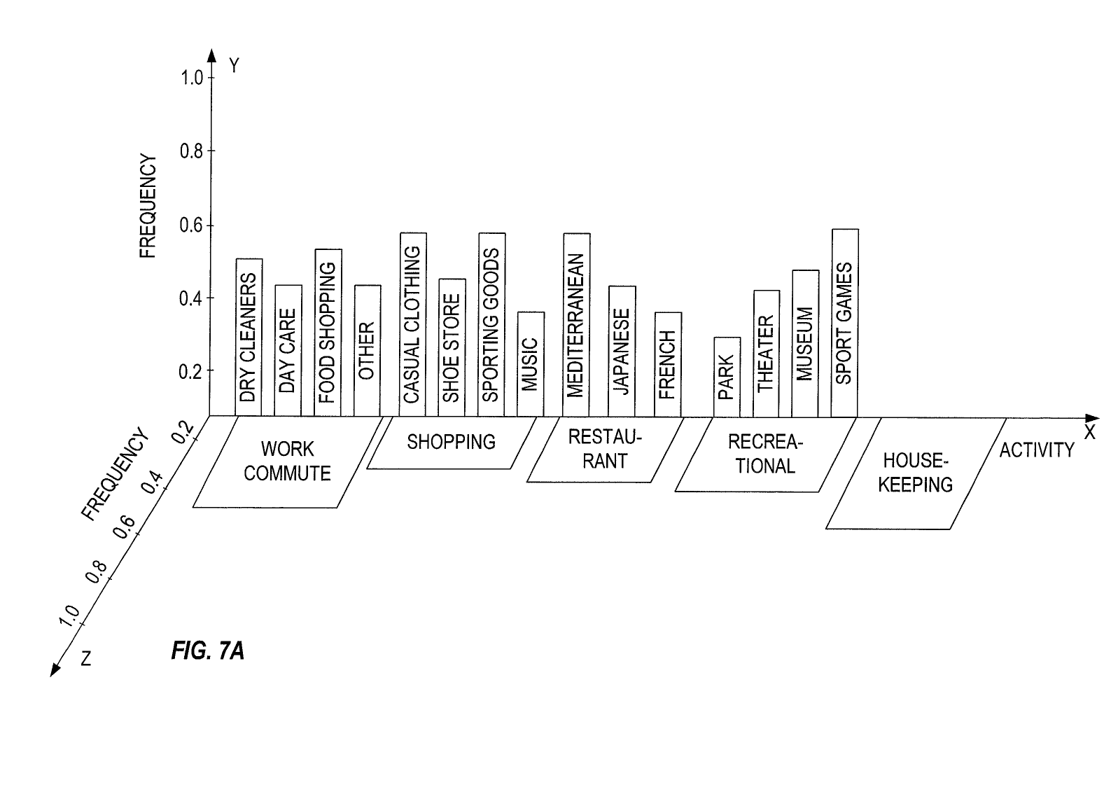

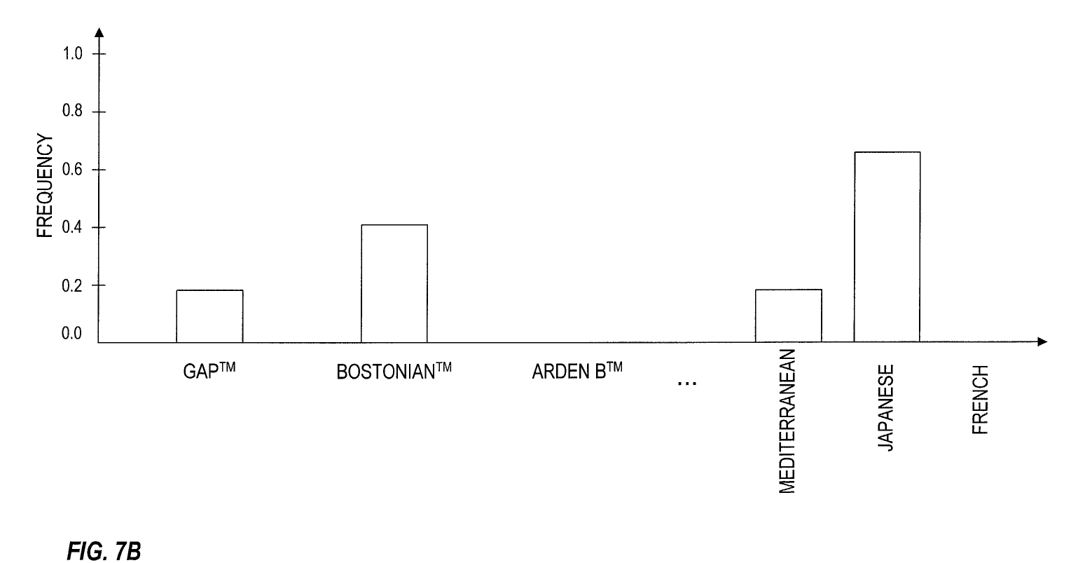

In one embodiment, the profiler monitors the “roaming” experience, records the destinations where the subscriber has been, referred to as subscriber location data (SLD). The SLD is then associated with an activity. The subscriber profile can then be updated using the new information. These last steps are useful in identifying new interests of the subscriber and also in determining the accuracy of the prediction by comparing the predicted activity and the activity actually performed by the subscriber FIG. 7A illustrates an exemplary activity profile in a 3 dimensional plot. On the (X, Z) plan, the type of activity and the frequency of each activity are illustrated. The frequency of a given activity measures the percentage of the number of times that the subscriber 210 participates in that activity. As illustrated, the subscriber activities are associated with commuting roughly 40% of the time and eating out (i.e., restaurant) approximately 20% of the time. As illustrated, the total percentage of time for the various activities adds up to more than one. This is because a single entry may be identified as separate activities. For example, if the subscriber 210 stops for dinner on their commute home this may be counted as commute and restaurant. In a preferred embodiment, each entry will only be associated with one activity and the total for all activities will equal 1.

The (X, Y) plan shows the frequency of each component of an activity. A component of an activity may be referred to as a sub-activity activity that is performed during the course of an activity. For example, the day care sub-activity may occur during a work commute to pick-up or drop off the subscriber's children. It may refer also to a specific type of activity when the activity has different variants. For example, as illustrated the restaurant activity is composed of different types of restaurants (e.g. Mediterranean, Japanese, French). As illustrated, the percentage of time that sub-activities are performed may equate to more than one if the same entry is identified as two sub-activities. For example, if the subscriber shops at a store that sells clothing and records. In a preferred embodiment, each entry will only be associated with one sub-activity and the total for all sub-activities associated with an activity will equal one.

FIG. 7A is an overall activity profile. The activity profile could also have a time element. As should be obvious to one skilled in the art, the activity profile would vary depending on the time of day, day of week, season, etc. For example, if the activity profile was associated with Mondays through Fridays from 8AM to 9AM it is likely that the activity profile would almost exclusively reflect commuting. Likewise if the activity profile was associated with weekends, it is likely that the activity profile would reflect family activities such as shopping, restaurants or recreational.

The subscriber activity profile may be used to predict the activity to which the subscriber is about to participate. In one embodiment, each activity and sub-activity is related to the season or time of the year, to the day of the week and time of the day and also a path through the location area that the subscriber takes to perform the activity. Such mapping of the activity in space and time allows the system to generate an activity pattern for each subscriber that may then be used in predicting the activities of the subscriber.

The location profile 570 may be generated based solely on the observed locations (530), and predict the location of the subscriber at a particular time. For example, the location profile 570 may predict that on Monday morning the subscriber is going to be at work, or that between 8:30 and 9:00 the subscriber is going to stop at 7-11. According to one embodiment, the location profile may be generated based on some combination of the observed data (activities, locations, devices, subscribers). Additionally, the location profile 570 may obtain data about the entities associated with the location, or within close proximity to the location. In a preferred embodiment the location profile 570 is a probabilistic determination of location based on time (i.e., season, month, day, hour), activity (i.e., vacation, entertainment), or other parameters.

A simple example would be that during your commute, the location profile 570 would predict your location as somewhere on the route between the commuting hours. Another example would be for the location profile 570 to predict your vacation location. If the activity/route profile 560 determined that the subscriber 210 is taking vacation based on the fact that it is Jul. 4^{th} week, the location profile may determine that it is likely that the subscriber 210 will take his vacation in the Outer Banks of North Carolina. Based on the predicted location, a predicted route can be generated. The route may be generated by extrapolating your driving patterns for commuting or other activities (i.e., highways vs. back roads, rerouting around construction areas) to get you to the vacation destination. The location for your vacation may be predicted based on past vacation locations, characteristics associated with past vacations, external data including but not limited to Internet browsing, television viewing habits, product and service purchases related to vacations, or a combination of some or all of these. For example, if you always travel to different beach resorts, have progressively been working your way south, and have visited numerous web sites related to the Outer Banks, the location profile 570 may identify your location for vacation as the Outer Banks.

FIG. 7B illustrates an exemplary subscriber location profile that identifies a frequency measure (i.e. how frequently the subscriber 210 goes to those locations) of locations where the subscriber 210 has been in the course of partaking in the activities described previously.

The subscriber profile 580 identifies characteristics associated with the subscriber 210. The characteristics may include demographic make-up, psychographic make-up, product preference, service preference, brand preference, and other features. The subscriber profile 580 may be developed from the observed data (activity, location, device, subscriber) and characteristics associated with the observed data. The associated characteristics may include probabilistic demographic make-up, or other criteria. Each activity or location may have an associated set of heuristic rules that define the probable characteristics of a subscriber 210. For example, if the subscriber 210 goes to the park every weekend, a potential characteristic of that subscriber 210 may be: a 20% chance they are single, a 50% they have a family, and a 30% chance they are retired. The characteristic may be modified based on what they do at the park, if the location data and map data can pinpoint with that accuracy. For example, if the data shows that they go to the playground the probability that the subscriber 210 has a family increases.

The heuristic rules for establishments, such as the GAP likely reflect characteristics associated with the target market of the establishment. There are numerous characteristics that could be associated with the locations, activities, routes, establishments, etc. and methods for applying these characteristics that would be well within the scope of the current invention.

In addition, the subscriber profile 580 could be based on the activity/route profile 560 and the location profile 570. For example, if the subscriber 210 stops at day care on their way to work that indicates that the subscriber 210 in all likelihood has children. Moreover, the subscriber profile 580 could be based on additional subscriber data associated with purchases, Internet browsing, television viewing habits, demographic data associated with the subscribers occupation or residence, and other data publicly or privately maintained (590). This additional subscriber data may be gathered and maintained by a third party not associated with wireless service, by the service provider, or a third party working in conjunction with the wireless provider.

According to one embodiment, the wireless device 110 has an Internet browser and as such can incorporate browsing activities into the subscriber profile 580. According to one embodiment, the wireless device 110 can make phone calls (i.e., wireless phone) and a profile can be generated based on the frequency (i.e., seldom, frequently) of phone calls and the establishments called (i.e., business, residence, operator). The profile could reflect the type of subscriber (i.e., business person, soccer mom).

According to another embodiment, the wireless device 110 may be equipped with a smart card or a wireless interface (i.e., blue tooth) that would allow the subscriber 210 to make purchases via their wireless device 110. The subscriber 210 could either be prompted to enter a personal identification number (PIN) or place a finger (i.e., thumb) over a portion of the wireless device 110 that could scan the fingerprint and send to an authorization server for authentication. This type of wireless device 110 would enable the purchase of products and services to be incorporated in the subscriber profile 580. According to another embodiment, the wireless device 110 may be equipped with the circuitry necessary to act as a universal remote control. Having a wireless device 110 that acts, as a universal remote would enable entertainment-viewing habits to be included in the subscriber profile 580.

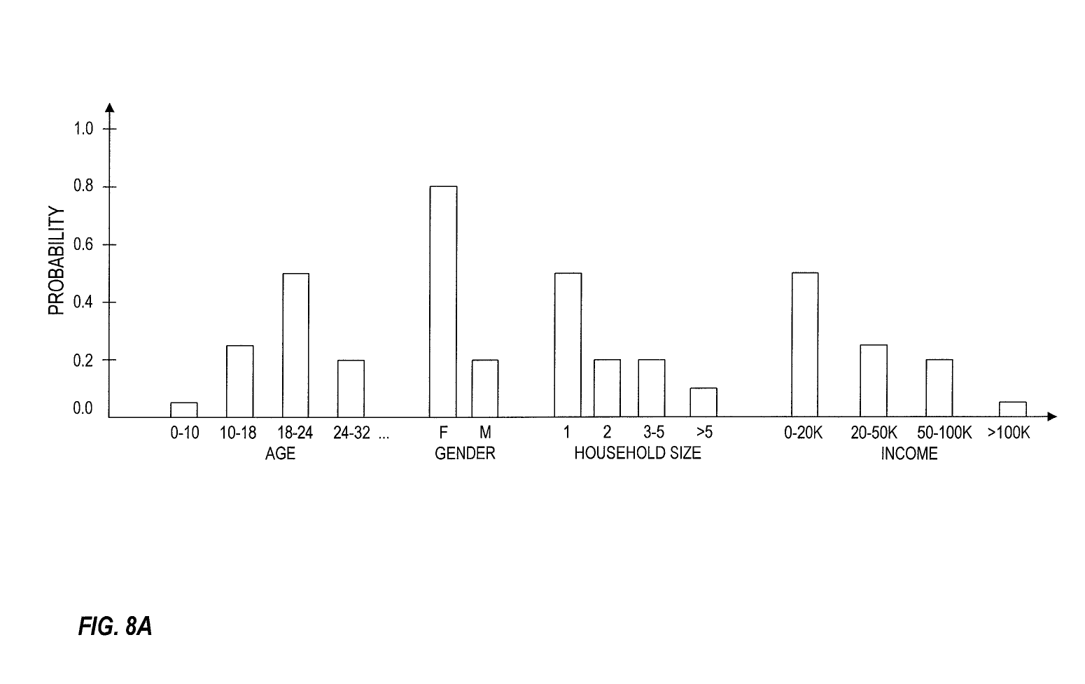

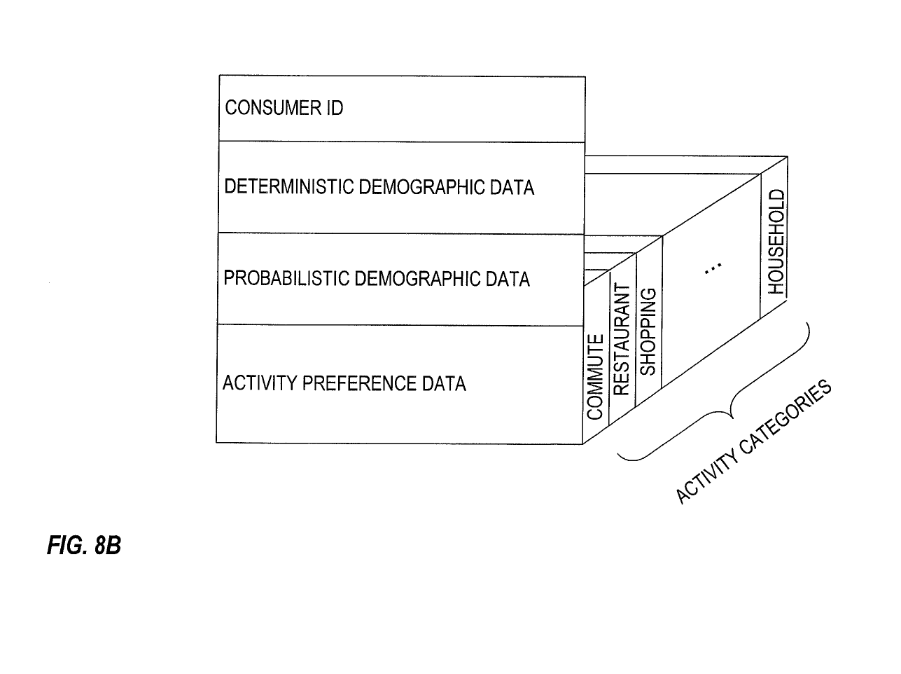

FIG. 8A illustrates an exemplary subscriber profile that identifies a probability that a subscriber 210 falls within a certain demographic category such as an age group, gender, household size, or income range. According to one embodiment, the subscriber profile includes interest categories that may be organized according to broad areas such as music, travel, and restaurants. Examples of music interest categories include country music, rock, classical, and folk. Examples of travel categories include “travels to another state more than twice a year”, and “travels by plane more than twice a year”.

FIG. 8B represents a data structure for storing the subscriber profile. As illustrated the subscriber profile includes a subscriber ID field (i.e., phone number, device IP address), a deterministic demographic data field (would likely be developed based on survey data filled out by the subscriber), a probabilistic demographic data field (to capture the exemplary profile illustrated in FIG. 8A), and one or more activity preference data fields (to capture the exemplary profile illustrated in FIG. 7A). As illustrated, the activity preference data field can be comprised of multiple fields arranged by activity categories. The data structure used to store the subscriber profile may be in the form of a table, record, linked tables in a relational database, series of records, or a software object.

Another embodiment of the current invention is to aggregate the data associated with subscribers 210 as it relates to a particular entity or location in order to develop (or update) a profile of the entity or location.

For example, if a particular entity (i.e., Starbucks) was interested in determining characteristics (most notably demographic) associated with their clientele, they could gather data about all the subscribers 210 that visit that location and generate an entity profile based on that data, or use the data to update a profile they already have. The data associated with the subscribers 210 may be the subscriber profile 580 generated by the method and system described above, may be a profile generated of the subscriber based on data the subscriber provides when they sign up for service, may be a profile generated by gathering data from third party databases (i.e., government or public), other type of profiles or some hybrid profile.

If an existing profile is updated some weighting factors need to be applied based on number of records or other criteria known to those skilled in the art. That is, the new profile should not be over or under compensated. The weighting factor may be so that the new profile effectively updates the existing profile. According to one embodiment, the data may be aggregated for a specific time period (i.e., one week, one month). The data may be aggregated in such a fashion as to eliminate or include repeat customers. In an alternative embodiment, the visits to the location could be enhanced with actual purchase data (either obtained by a third party or by the wireless device if it is capable of making cash/credit transactions).

As one of ordinary skill in the art would recognize, there are numerous reasons that an entity may wish to generate or update a clientele profile. The reasons include but are not limited to raising prices, developing an advertising strategy, remodeling, and new product launches.

The same logic discussed above with respect to an entity would apply to a location. For example, if a town was interested in characteristics associated with individuals that pass a particular location, or use a certain road, data about subscribers 210 who visit the location or use the road could be gathered and aggregated.

The concept of gathering data about the location of a subscriber 210 at all times or at set time intervals raises privacy concerns. As such it is preferable, that actual raw data is never saved. Instead the raw data may be aggregated in some fashion and the aggregated data is stored and processed. In another embodiment, the aggregated data is only stored for a predetermined time frame and is then deleted. For example, after a subscriber 210 signs up for wireless service the location data may be saved for a month (i.e., long enough to generate a profile). After the initial profile is developed the location data probably needs to be saved for less time (i.e., one week) as the profile can more easily be updated.

According to one embodiment, characteristics associated with the location are stored and processed instead of the raw data. For example, a major interstate between a small town and a major city is stored instead of the location coordinates of I-95 between Doylestown and Philadelphia. According to another embodiment, a profile associated with the location, activity, or route is generated and stored, and this profile is combined in some fashion with the existing profile.

The profiling of subscribers may be a standard practice that takes place if a subscriber 210 signs up for wireless service. In an alternative embodiment, the service may be standard but subscribers 210 can opt out. The subscriber 210 may have to pay a higher subscription rate in order to opt out of the profiling or may have to follow some process to opt out of the profiling. In an alternative embodiment, no profiling is standard and the subscriber 210 can opt in to the profiling. Subscribers 210 may be enticed to opt in to the profiling with cheaper wireless service, enhanced service, or other incentives that would be obvious to one of ordinary skill in the art.

Although this invention has been illustrated by reference to specific embodiments, it will be apparent to those skilled in the art that various changes and modifications may be made, which clearly fall within the scope of the invention.

What is claimed is:

1. A method for generating a profile of a subscriber by monitoring locations traveled by the subscriber, the method comprising:
receiving subscriber location data, wherein the subscriber location data identifies locations the subscriber has traveled;
retrieving location characteristics for the locations the subscriber has traveled; and
generating the profile based upon the subscriber location data and the location characteristics.

2. The method of claim 1, wherein the location characteristics include a description of the locations the subscriber has traveled.

3. The method of claim 1, wherein the location characteristics include establishments within the location.

4. The method of claim 3, further comprising retrieving a set of heuristic rules associated with the establishments, wherein said generating the profile includes generating the profile based on the subscriber location data, the location characteristics, and the s et of heuristic rules.

5. The method of claim 1, further comprising retrieving a set of heuristic rules associated with the locations the subscriber has traveled, wherein said generating the profile includes generating the profile based on the subscriber location data, the location characteristics, and the set of heuristic rules.

6. The method of claim 1, wherein the subscriber location data includes locations the subscriber has traveled and an associated time.

7. The method of claim 6, further comprising:
aggregating the subscriber location data by time;
analyzing the aggregated subscriber location data to identify trends; and
associating the trends with predicted activities.

8. The method of claim 7, further comprising associating a predicted route with each of the predicted activities.

9. The method of claim 7, wherein the predicted activities are a probabilistic measure of the likelihood of the subscriber partaking in particular activities.

10. The method of claim 8, wherein the predicted route is a probabilistic measure of the likelihood of the subscriber taking a particular route.

11. The method of claim 1, wherein said receiving subscriber location data includes receiving subscriber location from a wireless device.

12. The method of claim 1, wherein said receiving subscriber location data includes receiving subscriber location from a wireless network.

13. The method of claim 1, wherein a location of the subscriber is determined by a wireless network determining a location of a wireless device the subscriber has.

14. The method of claim 1, wherein a location of the subscriber is determined by a GPS chipset with in a wireless device the subscriber has receiving location coordinates from a GPS system.

15. A method for predicting an activity of a subscriber, the method comprising:
receiving subscriber location data associated with where the subscriber has traveled, wherein the subscriber location data includes location and time;
aggregating the subscriber location data;
analyzing the aggregated subscriber location data to identify trends; and
associating the trends with predicted activities.

16. The method of claim 15, wherein the subscriber has a wireless device that is capable of generating location data.

17. A method for profiling a location based on subscribers that travel to the location, the method comprising:
monitoring subscribers who travel to the location;
receiving a subscriber profile for each subscriber that travels to the location;
aggregating the subscriber profiles to generate a location profile.

18. The method of claim 17, the subscribers have wireless devices capable of generating location data.
